(19) United States
(12) Patent Application Publication
(10) Pub. No.: US 2012/0106203 A1
(43) Pub. Date: May 3, 2012

(54) Plug-In Module For A Modulary Constructed Lighting Means, Lighting Module For The Lighting Means, And Modulary Constructed Lighting Means

(76) Inventor: Christian Fricke, Dachau (DE)

(21) Appl. No.: 13/202,313

(22) PCT Filed: Feb. 15, 2010
(86) PCT No.: PCT/EP10/51860

§ 371 Date: Jan. 11, 2012

(30) Foreign Application Priority Data
Feb. 18, 2009 (DE) 10-2009-009-520.9

(51) Int. Cl. H01R 33/00

(52) U.S. Cl. 362/652

(57) ABSTRACT

A plug-in module for a modularly constructed lighting means comprising: an in particular hollow-cylindrical base with a first and a second current-conducting rail and with at least one guide element suitable for mechanically guiding at least one lighting module; a cap at one end of the base, which cap is coupled to the first and the second current-conducting rail for supplying electrical current; and a heat sink at another end of the base.

This patent application claims the priority of the German patent application 10 2009 009 520.9, the disclosure content of which is hereby incorporated by reference.

The invention relates to a plug-in module for a modularly constructed lighting means, in particular for streetlighting. The invention furthermore relates to a lighting module for the modularly constructed lighting means and a modularly constructed lighting means, in particular for streetlighting.

Lighting means, in particular for streetlighting, old town lighting or else outdoor lamps, have a wide variety of shapes and designs. At the same time, such old town lighting and streetlighting are part of the image of the town or city and often have particularly high aesthetic value.

However, old town lighting, streetlighting and outdoor lighting to date have demonstrated very high current consumption owing to the conventional incandescent lamps used. In addition, old town lighting, streetlighting and outdoor lighting often have different designs even on a communal level. This means that maintenance and replacement of old luminaires with correspondingly new ones are associated with a high degree of complexity and high costs since only small quantities often need to be produced for each communal or town or city administration. Even under today's standards of reducing the current consumption of lighting means for old town lighting, streetlighting and outdoor lighting, the different designs of the various luminaires in the towns and cities sector result in increased complexity in terms of development and design costs.

There is therefore the need for a lighting means which can be used in old town lighting, streetlighting and outdoor lighting of different forms and can in the process be matched to the individual requirements of the customer easily.

This requirement is taken into account by the subjects of the independent patent claims. Developments and configurations are given in the dependent claims.

The invention proposes a modularly constructed lighting means. This can be realized in a very flexible manner by virtue of its modular design, in particular as regards the various components, namely the light module, the heat sink, the electronics and the electrical connection. By virtue of using standardized modules, it is possible to freely set the light distribution. At the same time, current-saving optoelectronic components can be used for implementing such modules. The modules can be stacked, with the result that any required physical shape or physical height can be realized. Differently shaped modules whilst at the same time using standardized connections and mechanical joints reduce the development and manufacturing costs.

The principle of a modular system is thus realized with the invention, with the result that various already existing lighting solutions can be implemented by slightly modifying individual elements. By virtue of the use of modern current-saving modules, in particular based on semiconductors, markedly improved energy efficiency is achieved. At the same time, the visually appealing appearance is maintained in the switched-off state of the luminaire. A replacement for old town lighting, streetlighting and outdoor lighting which can be matched to different shapes by virtue of the proposed principle of the modular system without changing the existing image of the town or city is thus possible in particular.

In one embodiment, a plug-in module for such a modularly constructed lighting means, in particular for streetlighting, is provided.

Said plug-in module contains a basic body with a first and at least one second current-conducting rail and a further guide element. The latter is configured so as to mechanically guide at least one lighting module and therefore to ensure contact between the lighting module and the current-conducting rails. A cap which fits into a corresponding lampholder of the lighting, in particular the streetlighting, is provided at one end of the basic body. In addition, the cap is coupled to the first and the at least one second current-conducting rail for supplying an electrical current. A heat sink is provided at another end of the basic body.

With this embodiment, the cooling is positioned in the upper region of the plug-in module, remote from the cap.

Likewise, the invention proposed a lighting module for a modularly constructed lighting means, in which a module body with a cutout and a guide groove for accommodating the mechanical guide element of the basic body of the plug-in module are provided. The lighting module comprises a first current tap and a second current tap, which are configured so as to be coupled to a respective one of the first and second current-conducting rails of the basic body of the plug-in module. Furthermore, the lighting module contains a plurality of optoelectronic components, which are arranged on a side facing away from the cutout and are electrically coupled to the first and second current taps by a supply line.

Owing to the use of various lighting modules, it is thus possible for a modularly constructed lighting means with a plug-in module and a plurality of lighting modules to be implemented. In this case, it is possible for the module bodies of the lighting module to have different shapes and designs, with the result that different implementations in accordance with the principle of a modular system can be realized.

In one configuration, a lighting means with such a modular construction also comprises a cover element, which deflects light from the optoelectronic components of the at least one lighting module in the direction of the cap at the end of the base.

In a further configuration, the lighting module can additionally have a holder element and at least one cover element connected thereto. Said cover element serves to deflect an emission direction of light from the plurality of optoelectronic components which are arranged on the module body.

In order to enable them to be stacked, the various module bodies of the lighting modules can be provided with additional sealing elements. Said sealing elements can be individual or else can form part of the lighting module on the upper or lower side. As a result, when the lighting modules are plugged on to a corresponding plug-in module, an interspace between the individual lighting modules is sealed and thus the ingress of moisture, which could possibly lead to a short circuit, is avoided. At the same time, the sealing elements in one configuration serve to mechanically couple the various lighting modules. As a result, different alignments of the lighting modules with respect to one another can be implemented.

In a further configuration, a lighting module additionally comprises a spacer element, which is arranged above or below the module body. This spacer element can also have a cutout. In particular, the spacer element can comprise a shape similar to the module body. As a result, various lighting modules can be stacked one above the other, with the spacer elements ensuring a sufficient distance between the heat-generating optoelectronic components of the various lighting modules with respect to one another.

In one configuration of the invention, the first current-conducting rail and the second current-conducting rail are arranged on the outer surface of the base longitudinally and spaced apart from one another in the plug-in module. Correspondingly, in the lighting module, the current taps can be arranged on the inner side of the cutout, with the result that said current taps make contact with the correspondingly arranged current-conducting rails and thus produce the electrical contact when the lighting module is plugged on to the plug-in module.

Alternatively, the different current-conducting rails can be arranged substantially opposite one another and separated by at least one guide element. This makes it possible for the lighting modules to be built on to the plug-in module in a way which prevents them from being plugged in incorrectly and therefore avoids a short circuit as a result of improper construction.

The basic body of the plug-in module can in particular be hollow-cylindrical. The term “hollow-cylindrical” is understood in this context to mean a basic body which has an at least partially open cavity. The basic body can be round, oval or in the form of a polygon, depending on the desired configuration. The cap can be in the form of an Edison cap, a plug-in cap, a bayonet cap or else a special cap provided for streetlighting.

A control module which is configured so as to emit electrical energy to at least one lighting module which is coupled electrically to the plug-in module via the first and second current-conducting rails can be provided within the basic body. Furthermore, the control module is connected to the cap for drawing electrical energy. This can take place via further current-conducting rails or other means.

By means of the control module it is therefore possible to control the light emission of the individual lighting modules depending on external parameters such as sunlight, for example. Various color impressions, emission characteristics or else luminous intensities can therefore be realized. The control module is preferably arranged within the hollow-cylindrical base or at the other end of the base, namely the end remote from the cap, in thermal contact with the heat sink.

In an alternative embodiment, the control module is in the form of an independent module, which is plugged on to the plug-in module. In this case, it comprises current taps and current emitters. The current taps are coupled to the cap for supplying energy to the control module via rails on the basic body. The current emitters supply the lighting modules which are likewise plugged on to the basic body of the plug-in module.

The individual optoelectronic components of the lighting module are preferably connected electrically in parallel with one another and are electrically connected to the first and second current taps. The optoelectronic components can comprise light-emitting semiconductor bodies or else organic light-emitting diodes. The term “light-emitting semiconductor body” is understood to mean semiconductor components which emit light in a certain wavelength range during operation. By various conversion mechanisms or arrangements of light-emitting semiconductor bodies with different wavelengths, it is possible to realize various color impressions.

The invention will be explained in detail below using the drawings with reference to various embodiments. In said drawings:

FIG. 1 shows a first embodiment of a lighting means, in particular for streetlighting in accordance with the proposed principle,

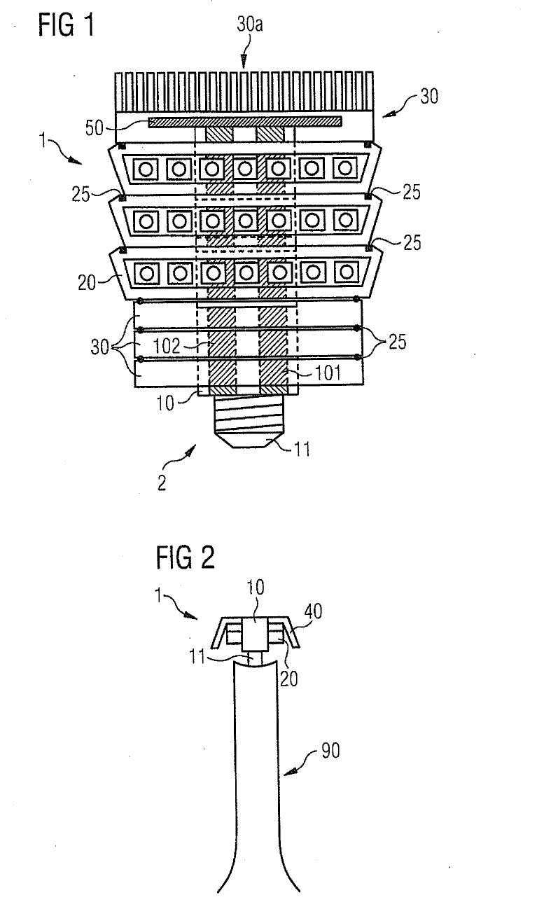

FIG. 2 shows an exemplary embodiment of streetlighting with a lighting means in accordance with the proposed principle,

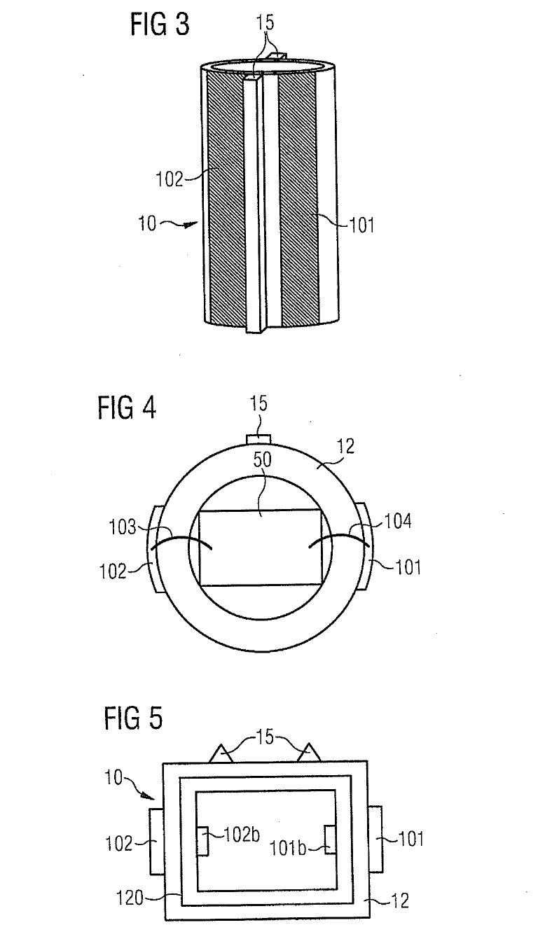

FIG. 3 shows a configuration in a schematic illustration of a base of a plug-in module in accordance with the proposed principle,

FIG. 4 shows a plan view of a further embodiment of a base of a plug-in module in accordance with the proposed principle,

FIG. 5 shows a further embodiment of a base in plan view in accordance with the proposed principle,

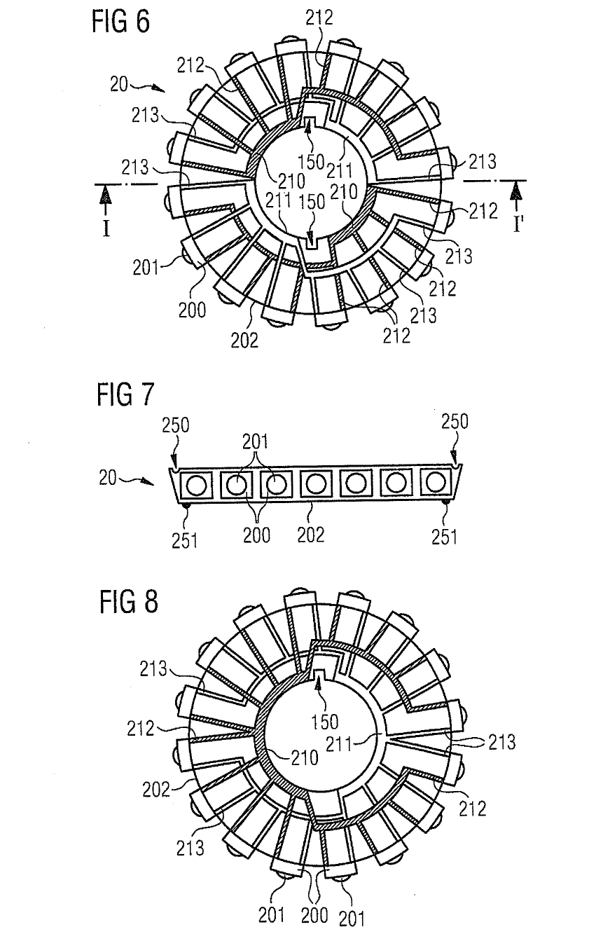

FIG. 6 shows an illustration of a plan view of a lighting module for a modularly constructed lighting means in accordance with the proposed principle,

FIG. 7 shows a side view through the section axis I-I′ shown in FIG. 6,

FIG. 8 shows a plan view of a further embodiment of a lighting module in accordance with the proposed principle,

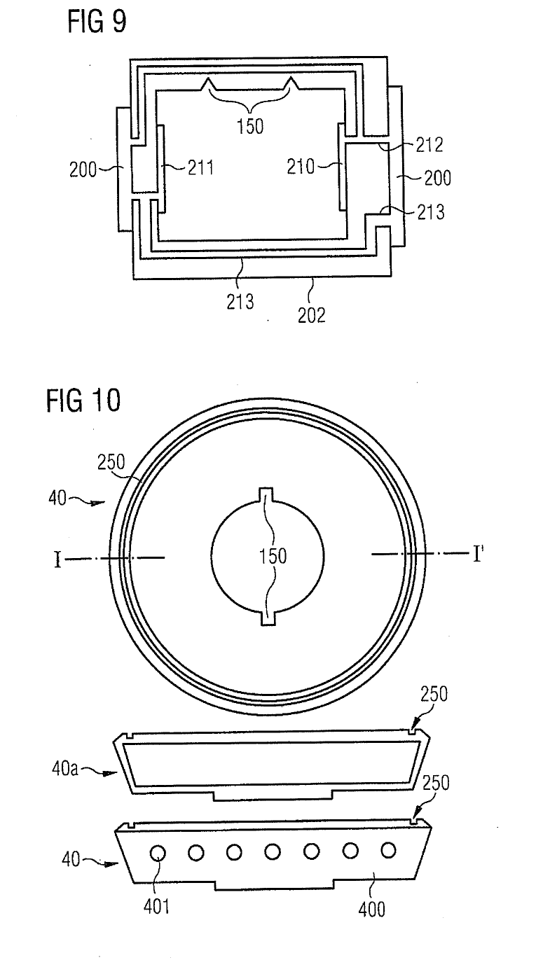

FIG. 9 shows a plan view of a third embodiment of a lighting module in accordance with the proposed principle,

FIG. 10 shows a plan view and a side view of an embodiment of a cover element in accordance with the proposed principle,

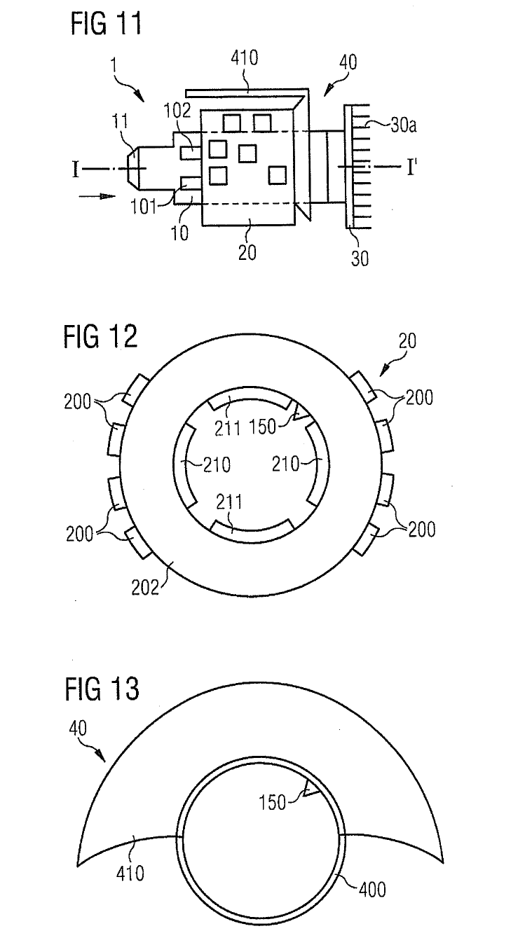

FIG. 11 shows a side view of a further embodiment of a modularly constructed lighting means in accordance with the proposed principle,

FIG. 12 shows a plan view of a lighting module in accordance with the embodiment shown in FIG. 11,

FIG. 13 shows a plan view of a cover element in accordance with the embodiment shown in FIG. 11.

Identical or functionally identical component parts can be provided with the same reference symbols in the exemplary embodiments and figures below. The figures and the size ratios, in particular also the size ratios of individual subregions and elements with respect to one another, cannot in principle be considered as being true to scale. Instead, they serve to illustrate individual aspects of the invention. They may have been configured so as to be excessively large or excessively thick for better understanding and/or improved clarity. The invention is also not restricted to the exemplary embodiments by the description with reference to said exemplary embodiments. Instead, the invention includes any novel feature and any combination of features which in particular also includes any combination of features in the patent claims, even if these features or this combination is not explicitly specified in the claims or in the exemplary embodiments.

In addition to the base proposed here in the form of a hollow cylinder, further embodiments serving as the basis for a base for a plug-in module according to the invention are also conceivable. The external shape of the lighting module is restricted to the exemplary embodiments illustrated here to a similarly small extent. In particular, the lighting module can be formed differently depending on the desired design and on external requirements.

The likewise explained coupling between the individual modules, in particular between the plug-in module and the lighting module within the modularly configured lighting means can also be configured differently. For example, contact-making via the sealing rings or the lighting modules with respect to one another is also possible. It is likewise possible for supply lines to be provided which lead from a control module arranged within the plug-in module directly to corresponding connections of the lighting modules.

FIG. 1 shows a schematic side view of a modularly constructed lighting means in accordance with the proposed principle. Said lighting means comprises a plurality of lighting modules and a plug-in module. The plug-in module 2 of the lighting means 1 comprises a cap 11, which is mechanically connected to a basic body or a base 10. A plurality of current-conducting rails 101 and 102 are arranged on the surface of the base 10, with two of said current-conducting rails being illustrated schematically here. A control module 50 is fastened at an opposite end of the base 10. This control module 50 is electrically connected to the cap 11, with the result that said cap provides a current to the control module 50 during operation of the lighting means 1, i.e. in a screwed-in state. In this case, this takes place either by means of current-conducting rails arranged at the rear (not shown here) or rails which run along an inside cutout in the base 10.

In this embodiment, the control module 50 is plugged on to the base and is in the form of an independent module. The module 50 contains a plurality of circuits and/or integrated circuits which generate the current and voltage necessary for the operation of the lighting module(s) from the power supply, coming from the cap. The control module 50 in turn emits this to the current-conducting rails 101 and 102 on the outer upper side of the base 10. Furthermore, the control module 50 can also comprise photosensors or time switches, with the result that control of the individual lighting modules is possible autonomously.

In addition, a plurality of lighting modules 20 are plugged on to the plug-in module 2. Each of the lighting modules comprises a plurality of optoelectronic components and a cover, which completely surrounds the components. The cover serves the purpose of uniformly distributing the light emitted by the optoelectronic components and thus producing a visually appealing impression during operation. In the switched-off state, the covers produce a good aesthetic overall impression, which fits into the street image. For this purpose, the covers arranged on the lighting modules 20 can comprise different embodiments, depending on the desired design. For example, individual covers on the lighting modules 20 can be designed to have different colors. They can consist of glass or plastic and be matt or transparent. Likewise, various shapes of the covers are also possible.

Depressions are applied to the respective upper side of the individual covers of the lighting modules 20, with sealing elements 25 being arranged in said depressions. Therefore, the various lighting modules 20 are stacked one above the other and fastened, with the result that no interspace is formed between the individual lighting modules. The sealing elements 25 are in this case in the form of a peripheral ring and prevent the ingress of moisture into the interspace between the individual lighting modules 20.

Further spacer elements 30 are arranged between the lower end of the base and the cap 11 and the first lighting module 20. Said spacer elements produce a sufficient distance between a lampholder (not illustrated here), into which the cap 11 of the plug-in module is screwed, and the first lighting module, with the result that sufficient heat dissipation is ensured. Furthermore, they are also used for the purpose of ensuring a uniform design with already existing streetlights of similar appearance.

Finally, a heat sink 30 is arranged at the other end of the base above the control module 40. This heat sink comprises a metallic basic body and a comb 30a arranged thereon for emitting heat. During operation of the lighting means, both the control module 50 and the individual lighting modules 20 generate waste heat, which is effectively emitted firstly via the cap 11 and secondly via the heat sink 30 and the comb 30a.

Various designs, colors and shapes for different applications and requirements can be realized with the modularly constructed lighting means illustrated in FIG. 1 on the basis of the principle of a modular system comprising lighting modules, including various covers, spacer elements and plug-in module. With the principle of a modular system, it is therefore possible to maintain and possibly replace various old town lights, streetlighting and outdoor lighting without a new lighting means needing to be completely designed and implemented each time.

In particular cover elements which can be applied both to the lighting modules and individually to spacer modules enable a free configuration of the appearance of the lighting means in the switched-off state. The current-conducting rails 102 and 101 illustrated here provide the required energy from the control module 50 to the lighting modules 20. Further current-conducting rails are arranged on the rear side (not shown) of the plug-in module in this embodiment, said current-conducting rails electrically conductively connecting the control module 50 to the lamp cap 11 and thus supplying the control module 50 with the required operating current and operating voltage.

FIG. 2 shows a configuration of an old town light in accordance with the proposed principle. The old town light comprises a light rod, with a current-conducting lampholder being fitted at the upper end thereof. The lighting means according to the invention is screwed into this lampholder via the cap 11. The cap 11 is part of a plug-in module, which also comprises the base 10. Various lighting modules 20 and a cover module 40 are fitted on the plug-in module. In the present exemplary embodiment, the cover module 40 is inclined downwards and comprises a mirrored surface arranged on the inside. During operation, light from the lighting modules 20 is thus reflected downwards from the mirrored surface. Thus, streetlighting is provided which generates the required brightness in the area provided for this purpose during operation and, in the switched-off state, gives a visually appealing impression.

FIG. 3 shows the base 10 of a plug-in module in accordance with the proposed principle.

Said base comprises a basic body. Two current-conducting rails 101, 102 are arranged on the upper side thereof and are used to supply electrical current to the lighting modules which can be plugged on to the base. For this purpose, the current-conducting rails 101 and 102 have supply lines to a control module (not shown here). Furthermore, two guide grooves 15 are provided, of which one is arranged between the two current-conducting rails. The guide grooves 15 serve to mechanically guide the individual lighting modules, with the result that, firstly, good mechanical stability is ensured and, secondly, a short circuit as a result of the lighting modules being plugged incorrectly on to the base is avoided.

The guide grooves 15 can furthermore have different configurations. This enables identification of lighting modules which can be plugged on or a selective choice of different lighting modules, of which only some can be plugged on, depending on a specific operating voltage, for example.

FIG. 4 shows the plan view of a base in accordance with a further embodiment in accordance with the proposed principle. The base of the basic body 12 is in turn in the form of a hollow cylinder, with the control module 50 being arranged in the inner region thereof. Said control module is connected firstly to the cap (not shown here) for supplying electrical energy. The control module 50 provides the required energy to the current-conducting rails 101 and 102 during operation of the lighting means via further feed wires 103 and 104. Said current-conducting rails, as illustrated, are arranged substantially on opposite sections on the outer side of the basic body 12 of the plug-in module. In order in turn to avoid a short circuit as a result of lighting modules being plugged on incorrectly, a guide rail 15 is applied to the outer surface of the basic body 12.

FIG. 5 shows a further configuration of a basic body of a plug-in module 10 in accordance with the proposed principle. Guide rails 15 are arranged on one side, and in turn the current-conducting elements 101 and 102 are arranged on two opposite sides on the outer surface. The basic body 12 is in the form of a hollow right parallelepiped and has an insulating layer 120 in its interior. Likewise, current-conducting rails 101b and 102b are applied to the inner side of said basic body. Said current-conducting rails are coupled to the cap (not illustrated here) of the plug-in module 10 for supplying electrical energy to a control module.

Instead of the control modules which have been disclosed thus far, which are arranged in the basic body, control modules can also be part of the corresponding lighting module. In such a case, current-conducting rails are provided on the basic body and are coupled to a control unit of a lighting module via corresponding contact being made. The control unit of the lighting module is thus supplied with the required energy and provides the required operating voltage for the optoelectronic components of the lighting module. This enables operation of individual lighting modules independently of one another. In addition, the control modules can be manufactured in a simpler manner since they in each case only need to supply the components of one lighting module.

An embodiment of a lighting module in plan view is shown in FIG. 6. The corresponding sectional illustration in FIG. 7 is shown along the axis I-I′.

The lighting module 20 in this case comprises a module body 202 in the form of a hollow cylinder with an inner cutout. A first current tap 210 and second current tap 211 are arranged on the surface of this inner cutout. The arrangement is produced in such a way that the current taps make electrical contact with the current-conducting rails provided on the plug-in module when the lighting module is plugged on to a corresponding plug-in module and thus produce the conductive contact. In order to improve contact-making, the current taps can also be configured with spring elements, which press the current taps on to the corresponding current-conducting rails and thus produce intimate contact.

Furthermore, the inner cutout comprises two guide grooves 150. Said guide grooves fit into the corresponding guide rails 15 of the plug-in module, as a result of which “incorrect plugging” of the lighting module 20 on to the plug-in module is avoided. At the same time, the mechanical stability of the lighting means is improved.

The current taps 210 and 211 are coupled to various optoelectronic components 200 via corresponding supply lines 212 and 213. Said optoelectronic components are arranged on the outer surface of the module body 202 and are connected electrically in parallel with one another.

The optoelectronic components 200 are in the form of organic light-emitting diodes, for example. Alternatively, they are also in the form of semiconductor light-emitting diodes. By virtue of selecting different material systems, it is possible to produce different color impressions since the optoelectronic components therefore emit light of different wavelengths. The optoelectronic components 200 can contain various material systems, but also conversion materials, in order to produce light of different wavelengths and thus to produce mixed colors. In this way, it is possible, inter alia, for white light with different color temperatures to be implemented. By controlling the voltage or the current for supplying the individual optoelectronic components, it is possible for the luminous intensity, but also the color temperature, to be varied.

In this embodiment, lighting distribution boards 201 are applied to the optoelectronic components and produce an optically uniform light distribution of the light emitted by the components 200. In addition, these elements can also contain conversion materials for converting and/or producing mixed colors.

The lighting modules 20 have slight depressions 250 on their upper side for accommodating sealing materials or sealing rings 251. As a result, the individual lighting modules can be arranged one above the other, with the sealing ring 251 of a lighting module engaging in the depression 250 of a lighting module arranged therebeneath and sealing said lighting module.

FIG. 8 shows a plan view of a further lighting module in accordance with the proposed principle. In this case, two current taps 210 and 211 are provided in the inside cutout of the hollow-cylindrical module body 202. The two current taps are arranged substantially opposite one another and are spaced apart by an individual guide groove 250 in the inner cutout.

In this case too, a plurality of optoelectronic components 200 with conversion materials 201 arranged thereon are provided on the outer surface of the module body 202. Individual feedlines lead from the contacts of the optoelectronic components 200 to the current taps 210 and 211. The feedlines are configured, at different heights or depths of the module body 202, with an insulating layer between the feedlines and in particular the points of intersection. The guide groove 150 in turn prevents the lighting module 20 from being plugged incorrectly on to a corresponding plug-in module. As a result, a short circuit or opposite polarization of the optoelectronic components is avoided.

In addition to the circular lighting modules illustrated here, other designs and embodiments can also be realized. FIG. 9 shows a further example, in which the module body 202 of the lighting module is in the form of a hollow right parallelepiped or a rectangular hollow cylinder. Two guide grooves 150 are provided in the inner cutout in the upper region, with the result that this lighting module can be plugged on to the corresponding plug-in module shown in FIG. 5, for example. Current taps 210 and 211 are arranged on the two transverse sides of the inner cutout. Said current taps are connected to corresponding flat optoelectronic components 200 on the side faces of the lighting module via internal feedlines 212 and 213 passing through the module body 202. In the embodiment, the optoelectronic components 200 are configured so as to have a large area. Feedlines lead through the insulating basic body 202 of the lighting module 213 and thus connect the two optoelectronic components on the surface of the basic body 202 to the corresponding current taps on the inner side of the cutout.

In addition, the lighting modules can contain additional cover elements. As an alternative, it is also possible for spacer disks or spacer elements to be formed with such cover elements. In this case, the cover elements can substantially follow the shape of a lighting module, with the result that said cover elements can be turned back over the lighting module and surrounded thereby. In addition, it is possible for cover elements to be provided with corresponding depressions and sealing elements, with the result that the optoelectronic components and the lighting elements of the lighting module are completely surrounded by a cover element.

Such cover elements can be colored and opaque, colored and translucent or else partially mirror-coated. They can consist of transparent glass or plastic or matt-translucent glass or plastic. Additional different embodiments and designs are possible in order to take account of the sometimes very different old town lighting and streetlighting of different communal areas.

In this way, different cover elements can be combined with the module bodies and the optoelectronic components and thus differently designed and configured lighting modules can be realized. In the embodiment illustrated in FIG. 10, the cover is substantially circular, with the inner cutout having guide grooves 150. The sectional view along the axis I-I′ is illustrated in both of the lower subfigures in the form of two different cover elements 40a and 40.

The cover 40a comprises a translucent plastic, while the cover 40 has a plurality of cutouts 401 in the region of the optoelectronic components on the module body. The cover body 400 furthermore, has a cutout 250 in a first side, said cutout being circular and being configured so as to accommodate a corresponding sealing ring. When the lighting module, including the cover element 40 or 40a, is assembled, in each case one sealing ring is inserted into the depression 250 when various lighting modules and cover element are plugged one on top of the other. The covers 40 and 40a illustrated enable a free configuration of the appearance and protect both the module body and the optoelectronic components arranged on the module body by virtue of the sealing element between two lighting modules stacked one on top of the other.

In addition to the circular cover elements illustrated in FIG. 10, other configurations are also conceivable. In this regard, FIG. 11 shows an embodiment of a lighting means, which, in contrast to the configuration in FIG. 1, is not inserted perpendicularly into a lampholder, but horizontally into the lampholder, for example along the axis I-I′. This embodiment is suitable for use in old town lighting or streetlighting in which the lighting means is substantially horizontal to the street.

The lighting means in FIG. 11 is constructed from a plug-in module, a lighting module 20 and a cover module 40. The plug-in module surrounds the cap 11 intended to be screwed into a corresponding lampholder, a base 10 with a plurality of current-conducting rails 101 and 102 and, at the end remote from the cap 11, a control module 50 and a heat sink 30 with a comb 30a for emitting thermal energy during operation. The lighting module 20 has been plugged on to the plug-in module and mechanically fixed to the cover module 40.

FIG. 12 shows a plan view along the axis I-I′ shown in FIG. 11 of the lighting module 20. Said lighting module is circular in the form of a hollow cylinder and, in addition to a guide groove 150, also contains a plurality of current taps 210 and 211 in its inner cutout. The current taps 211 and 210 are each arranged opposite one another. The guide rail 150 engages in a corresponding guide groove in the base 10 of the plug-in module and serves to mechanically fix the lighting module on the plug-in module. A plurality of optoelectronic components 200 are arranged on the outer side of the module body 202. Said optoelectronic components are configured in such a way that they emit light substantially sidwewards.

FIG. 13 shows the plan view along the axis I-I′ in FIG. 11 of the cover element 40. The cover element 40 comprises a cover body 400, which is likewise circular, with a cutout and a guide rail 150 arranged therein. The groove is substantially in the same position as the guide rail 150 of the lighting module 20 in FIG. 12. Furthermore, a cover shield 410 is provided, which spans the cover body 400 in the form of a semicircle. The cover shield 410 is mirror-coated and is configured in such a way that, in connection with the lighting module 20, it deflects light from the components 200 in the desired direction, in this case downwards. At the same time, the cover shield 410 serves to protect the lighting module 20 from rain or similar external environmental influences.

During operation of the lighting means shown in FIG. 11, light from the components 200 which is emitted sidewards is deflected downwards by the cover shield 410. For this purpose, the cover shield 410 is configured in the form of a parabola. In the switched-off state, the cover shield serves to produce a visually appealing state of the lighting means and can be similar to lighting means for old town lighting or streetlighting which are conventional and similar and are already used, for example.

By virtue of the proposed principle of a modular system comprising a plug-in module and a lighting module, including various covers, which can be both independent and part of the lighting module, a lighting means is provided which can be used in a large number of old town lighting and streetlighting or outdoor lighting systems. The principle of the modular design enables various designs, shapes and colors to be configured without the lighting means needing to be completely redeveloped. Precisely in the sector of towns and cities, in which old town lighting and streetlighting are matched to the respective street image, the proposed principle comprising plug-in modules and lighting modules enables simple maintenance of already existing systems or replacement by energy-efficient and economical lighting means, without disrupting the aesthetic impression.

1. A plug-in module for a modularly constructed lighting means comprising:
a hollow-cylindrical base with a first and a second current-conducting rail and with at least one guide element suitable for mechanically guiding at least one lighting module;
a cap at one end of the base, which cap is coupled to the first and the second current-conducting rail for supplying electrical current; and
a heat sink at another end of the base.

2. The plug-in module according to claim 1, wherein the first current-conducting rail and the second current-conducting rail are arranged on the outer surface of a basic body longitudinally and spaced apart from one another.

3. The plug-in module according to claim 2, wherein the first current-conducting rail and the second current-conducting rail are arranged substantially opposite one another and are spaced apart by the at least one guide element.

4. The plug-in module according to claim 1, further comprising a control module, which is coupled to the first and the second current-conducting rail for emitting electrical energy to at least one lighting module and is connected to the cap for drawing electrical energy.

5. The plug-in module according to claim 4, wherein the control module is arranged within a hollow-cylindrical basic body or at the other end of the base in thermal contact with the heat sink.

6. A lighting module for a modularly constructed lighting means comprising:
a module body with a cutout and a guide element for accommodating the mechanical guide element of the base of the plug-in module;
a first current tap and a second current tap, which are configured so as to be coupled to a respective one of the first and second current-conducting rail of the base of the plug-in module; and
a plurality of optoelectronic components, which are arranged on one side of the module body, said side facing away from the cutout, and are electrically coupled to the first current tap and to the second current tap by supply lines.

7. The lighting module according to claim 6, wherein the optoelectronic components are connected electrically in parallel with one another and are connected to the first and second current taps.

8. The lighting module according to claim 6, wherein the optoelectronic components comprise light-emitting semiconductor bodies and/or organic light-emitting diodes.

9. The lighting module according to claim 6, wherein the module body has a hollow cylinder, on the outer side face of which the plurality of optoelectronic components are arranged.

10. The lighting module according to claim 6, wherein the module body has a hollow cylinder, on the inner side face of which the first current tap and the second current tap are arranged.

11. The lighting module according to claim 6, further comprising:
a spacer element, which is arranged above or below the module body.

12. The lighting module according to claim 6, further comprising:
a holder element; and
at least one cover element, which is fastened on the holder element, for deflecting an emission direction of light from the plurality of optoelectronic components.

13. The lighting module according to claim 11, wherein the holder element is fastened on the spacer element or on the module body.

14. (canceled)

15. The modularly constructed lighting means according to claim 14, wherein at least one cover element is provided, which deflects light from the optoelectronic components of the at least one lighting module in the direction of the cap at the end of the base.

16. A modularly constructed lighting means comprising:
a plug-in module for a modularly constructed lighting means, comprising:
an in particular hollow-cylindrical base with a first and a second current-conducting rail and with at least one guide element suitable for mechanically guiding at least one lighting module;
a cap at one end of the base, which cap is coupled to the first and the second current-conducting rail for supplying electrical current;
a heat sink at another end of the base; and
at least one lighting module for a modularly constructed lighting means comprising:
a module body with a cutout and a guide element for accommodating the mechanical guide element of the base of the plug-in module; and
a first current tap and a second current tap, which are configured so as to be coupled to a respective one of the first and second current-conducting rail of the base of the plug-in module; and
a plurality of optoelectronic components, which are arranged on one side of the module body, said side facing away from the cutout, and are electrically coupled to the first current tap and to the second current tap by supply lines.

17. The modularly constructed lighting means according to claim 16, wherein the first current-conducting rail and the second current-conducting rail are arranged on the outer surface of a basic body longitudinally and spaced apart from one another.

18. The modularly constructed lighting means according to claim 17, wherein the first current-conducting rail and the second current-conducting rail are arranged substantially opposite one another and are spaced apart by the at least one guide element.

19. The modularly constructed lighting means according to claim 16, further comprising:
a control module, which is coupled to the first and the second current-conducting rail for emitting electrical energy to at least one lighting module and is connected to the cap for drawing electrical energy.

20. The modularly constructed lighting means according to claim 19, wherein the control module is arranged within a hollow-cylindrical basic body or at the other end of the base in thermal contact with the heat sink.

21. The modularly constructed lighting means according to claim 16, wherein the optoelectronic components are connected electrically in parallel with one another and are connected to the first and second current taps.

22. The modularly constructed lighting means according to claim 16, wherein the optoelectronic components comprise light-emitting semiconductor bodies and/or organic light-emitting diodes.

23. The modularly constructed lighting means according to claim 16, wherein the module body has a hollow cylinder, on the outer side face of which the plurality of optoelectronic components are arranged.

24. The modularly constructed lighting means according to claim 16, wherein the module body has a hollow cylinder, on the inner side face of which the first current tap and the second current tap are arranged.

25. The modularly constructed lighting means according to claim 16, further comprising:
a spacer element, which is arranged above or below the module body.

26. The modularly constructed lighting means according to claim 16, further comprising:
a holder element; and
at least one cover element, which is fastened on the holder element, for deflecting an emission direction of light from the plurality of optoelectronic components.

27. The modularly constructed lighting means according to claim 25, wherein the holder element is fastened on the spacer element or on the module body.
